(19) United States
(12) Patent Application Publication
(10) Pub. No.: US 2019/0154881 A1
(43) Pub. Date: May 23, 2019

(54) BACK SIDE ANTI-REFLECTIVE COATINGS, COATING FORMULATIONS, AND METHODS OF COATING OPHTHALMIC LENSES

(71) Applicant: SHAMIR OPTICAL INDUSTRY LTD., Upper Galilee (IL)

(72) Inventors: Zohar KATZMAN, Haifa (IL); Benny NOV, Kfar Yuval (IL)

(21) Appl. No.: 16/192,163

(22) Filed: Nov. 15, 2018

Related U.S. Application Data
(63) Continuation-in-part of application No. PCT/IL2017/050547, filed on May 16, 2017.
(60) Provisional application No. 62/337,589, filed on May 17, 2016.

(51) Int. Cl. G02B 1/115; B24B 13/005; B29D 11/00; G02C 7/10; G02C 7/02

(52) U.S. Cl. CPC G02B 1/115; B24B 13/0057; G02C 7/022; G02C 7/10; B29D 11/00923

(57) ABSTRACT

Ultraviolet (UV) radiation can harm the eye. Fortunately, a spectacle lens can be coated with a UV anti-reflection (AR) coating to reduce the amount of UV radiation incident on the eye. If the AR coating is on the back side of the lens (the convex surface closest to the eye), the AR coating will reduce the amount of UV light that is transmitted through the lens to the eye. It will also reduce the amount of UV light that is reflected off the back side of the lens toward the eye. The AR coating may include five or more alternating layers of silicon nitride and silicon dioxide or other suitable dielectric materials. It can be sputtered onto the back side of the lens as part of an on-block manufacturing (OBM) process while the ophthalmic lens blank is still attached to the block, before the ophthalmic lens blank is removed and edged.

### CROSS-REFERENCE TO RELATED APPLICATION(S)

This is a Continuation-in-Part of Application No. PCT/IL2017/050547 filed May 16, 2017, which claims the benefit of U.S. Application No. 62/337,589, filed on May 17, 2016, and entitled “Back Side Anti-Reflective Coatings, Coating Formulations, and Methods of Coating Ophthalmic Lenses.” Both of these applications are hereby incorporated herein by reference in their entireties.

### BACKGROUND

In order to reduce ocular exposure to harmful wavelengths and increase general comfort, it is desirable to filter the harmful light rays transmitted through an ophthalmic lens, such as a transparent spectacle lens, and to reduce reflections of these rays reflected off the back of the lens. Some of these reflections may come from light sources located behind the wearer of the spectacles. The reduction of reflections off the back side of the lens reduces glare from visible light, which can be a nuisance when wearing transparent eyewear and can be particularly uncomfortable when wearing sunglasses, and ultraviolet (UV) reflections, which can be particularly harmful to the eye. This can be achieved by using reflective coatings and anti-reflective (AR) coatings on the front and back sides of the lens as well as absorbers in mass additives to the bulk lens material/substrate or coatings.

AR coatings with more layers can provide better performance (lower reflection) over a broader wavelength range than AR coatings with fewer layers, e.g., as disclosed in U.S. Pat. No. 8,690,322 to Cado et al., which is incorporated by reference herein. However, making an AR coating with more layers tends to require more materials and take longer than making an AR coating with fewer layers. It can also be more expensive to make an AR coating with more layers.

A lens with AR coatings should be aesthetically pleasing. For spectacles, it is preferred that the lens is transparent, and that the coating is unnoticeable to those observing it. A drawback of many existing AR coatings is their coloration. The coloration can vary depending on the topography of the substrate and the Angle of Incidence (AOI) of the light reflected off the coated surface. The coloration of a coating can also influence the appearance of a tinted lens. An optimal coating is transparent over a wide range of angles and over the surface of the lens. When designing an AR coating, a certain level of control over the tint can be optimized by applying constraints on the target desired reflectance at particular wavelengths. For example, if a local peak exists in the reflectance spectra at about 420 nm, the lens will have a slight blue tint.

Many lens manufacturing processes involve machining the back surface of the lens blank with a free form generator. In these cases, the lens blank front surface can be pre-coated and fully processed. However, the back surface must be coated after it has been surfaced according to the desired ophthalmic specification (e.g., the Rx or lens prescription, lens design, etc.), which increase manufacturing time, cost, and complexity.

### GENERAL DESCRIPTION

Embodiments of the present technology include an optical article, such as an ophthalmic lens, comprising a transparent AR coating disposed on the back side, or concave side, of the optical article to reduce reflection of ultraviolet and visible light towards the wearer's eye(s). The optical article may also have another AR coating on the front side with reduced transmission of UV and visible light. The back side AR coated may be a broadband AR coating comprising thin films of Silicon Nitride (Si₃N₄) and Silicon Dioxide (SiO₂) deposited on the back side of the lens with ion-beam sputtering.

In some cases, the thin films can be sputtered onto the lens or lens blank in an on-block manufacturing (OBM) process without removing the block from the lens-on-block (LOB). In an OBM process, an unfinished or partially finished lens blank is “blocked” or “adhered” to a chuck, also known as a lens block, block, or workpiece, throughout the manufacturing. In a conventional OBM process, the lens is generally be de-blocked prior to coating application. In an inventive OBM process, however, an AR coating can be sputtered onto the back side of the lens while the lens is attached to the block.

Sputtering the films onto the blocked lens offers a number of advantages. First, sputtering takes less time than evaporation (e.g., 6-14 minutes instead of 30-35 minutes). Second, sputtering exposes the LOB to lower temperatures than those used in PVD evaporators, which reduces thermal stress on the lens blank, the lens block, and the epoxy holding the lens blank to the lens block. Third, sputtering the films onto the blocked lens reduces the risk of damage to the front-side coating by eliminating the need to de-block the lens for coating and to re-block the lens for further processing. Fourth, the sputtered coatings yield surprisingly good optical performance, e.g., with Silicon Nitride (Si₃N₄) and Silica (SiO₂), which are both products of reactions of a single Silicon target reacted either with O₂ or N₂. Other materials, such as metal oxides, (e.g., zirconia (ZrO₂)) and silica, may be sputtered using additional targets. Fifth, the sputtered coating in combination with a hard coating yields surprisingly good abrasion resistance. Abrasion resistance is an important property relating to the overall lifetime of the LOB, and subsequently for functional properties of the lens after de-blocking. Scratches on the surface of a lens can cause visual discomfort to the wearer, and decreases the aesthetic appearance of the eyewear. In addition, the abrasion resistance of the backside coating on the LOB is of particular importance due to the harsh de-blocking process that can potentially cause scratching and other defects on the back surface.

Embodiments of the present technology also include an ophthalmic lens, such as a prescription spectacle lens, with a front surface and a back surface. The back surface is coated with an AR coating that comprises alternating layers of silicon nitride and silicon dioxide and has a UV weighted average reflection factor between 280 nm and 380 nm of less than about 5%. The UV weighted average reflection factor may be measured over a range of angles of incidence (AOIs) from about 0° to about 45°. In some cases, the UV weighted average reflection factor between 280 nm and 380 nm may be less than about 2.5% over AOIs within a range of about 0° to about 45°. The AR coating may also have a maximum reflectance of about 5% at an AOI of about 0 degrees over a wavelength range from about 400 nm to about 700 nm.

There may between three and eight (e.g., five, six, or seven) alternating layers of silicon nitride and silicon dioxide. In one example with five layers, a first layer of silicon dioxide has a thickness between 61 nm and 77 nm; a first layer of silicon nitride has a thickness between 92 nm and 108 nm; a second layer of silicon dioxide has a thickness between 13.4 nm and 36 nm; a second layer of silicon nitride has a thickness between 8.5 nm and 22 nm; and a third layer of silicon dioxide has a thickness between 40 nm and 200 nm.

Other inventive embodiments include a method of forming an anti-reflection coating on an ophthalmic lens by sputtering alternating layers of silicon dioxide and silicon nitride onto a back side of a lens blank. The alternating layers of silicon dioxide and silicon nitride may be sputtered onto the lens blank while the lens blank is affixed to a lens block.

Still other inventive embodiments include a lens on block (LOB) that includes a block, an ophthalmic lens blank having a front surface and a back surface, an adhesive, and an anti-reflection coating. The adhesive is disposed between the block and the front surface of the ophthalmic lens blank to hold the ophthalmic lens blank to the block. And the anti-reflection coating includes at least five alternating layers of silicon nitride and silicon dioxide disposed on the back surface of the ophthalmic lens blank. For example, the alternating layers of silicon nitride and silicon dioxide may comprise: a first layer of silicon dioxide having a thickness between 61 nm and 77 nm; a first layer of silicon nitride disposed on the first layer of silicon dioxide and having a thickness between 92 nm and 108 nm; a second layer of silicon dioxide disposed on the first layer of silicon nitride and having a thickness between 13.4 nm and 36 nm; a second layer of silicon nitride disposed on the second layer of silicon dioxide and having a thickness between 8.5 nm and 22 nm; and a third layer of silicon dioxide disposed on the second layer of silicon nitride and having a thickness between 40 nm and 200 nm.

Yet another inventive embodiment includes a method of forming an anti-reflection coating on an LOB that comprises an ophthalmic lens blank affixed to a lens block with an adhesive. This method includes heating the LOB so as to dry and/or degas the LOB, then allowing the LOB to cool. Once the LOB is cool(er), the back surface of the ophthalmic lens blank is cleaned. Then alternating layers of dielectric material are sputtered on the back surface of the ophthalmic lens blank, e.g., using reactive ion-beam sputtering, to form the anti-reflection coating.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a schematic diagram that illustrates how harmful radiation can reach the eye of a person wearing eyewear.

FIGS. 2A and 2B are flowcharts that illustrate an on-block manufacturing (OBM) process for making an ophthalmic lens with sputtered back side AR coating.

FIGS. 2C and 2D are plots of various sputtering parameters, including power, voltage, chamber pressure, and gas flow rates into the chamber over the duration of an example of the AR coating application.

FIG. 3 is an exploded view of a blocked lens, including a lens blank with a back surface and a front surface, layers of hard coating, anti-reflection coating, top coating and grip coating on the back surface of the lens blank, a lens blocking piece, and an adhesive layer that affixes the lens blocking piece to the front surface of the lens blank.

FIG. 4 is a plot of reflectance spectra for a sputter Si₃N₄/SiO₂ coating at different angles of incidence (AOIs).

### DETAILED DESCRIPTION

Before detailed description of exemplary embodiments, clarification of terms and parameters used in this application may be helpful in understanding aspects of the disclosed technology. Unless otherwise stated, in this specification:
1) A coating system is taken to be a multi-layered structure comprising coating layers of various thicknesses and material properties;
2) The terms blocked lens, lens block assembly, and Lens on Block (LOB) refer to the assembly of a lens blank coupled to a lens block, including any adhesive layers, coating systems on the front and/or rear surfaces of the lens blank, and coatings on the lens block;
3) The terms front side, front surface, front face, and front main face refer to the surface of the ophthalmic lens that is the most distant from the wearer's eye (the front side is usually convex);
4) The terms back side, back surface, back face, back main face, rear side, rear surface, rear face, and rear main face refer to the surface of the ophthalmic lens that is closest to the wearer's eye (the back side is usually concave).

### Radiation Pathways to the Eye and Back Side AR Coatings

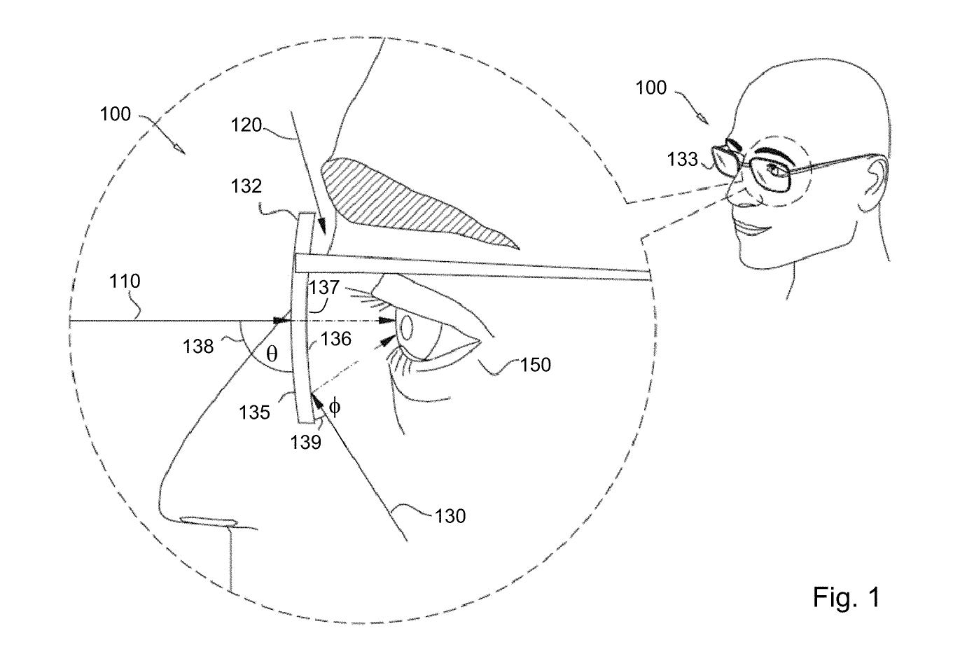

FIG. 1 schematically illustrates several radiation paths that end in an eye 150 and are possibly transmitted or reflected off an ophthalmic lens 132 (e.g., a prescription lens) of some eyewear 100. Radiation can travel along a direct pathway 110 through the front side 135 (or convex side) of the ophthalmic lens 132 at an angle of incidence (AOI) θ 138, for example, 90 degrees, through the back side 136 (or concave side) of the lens 132, at an AOI Ø 139 and into the eye 150. Radiation can also follow a pathway 130 that includes reflection off of the concave/back side 136 of the ophthalmic lens 132 and into the eye 150. Radiation can follow a pathway 120 passing into the eye 150 around the frame 133 unobstructed by the eyewear 100. (This effect may be more pronounced, for example, in eyewear 100 with smaller frames).

Unlike other lenses, the lens 132 shown in FIG. 1 has an AR coating 137 deposited on its back side 136, possibly in addition to a coating (not shown) on its front die 135. This AR coating 137 provides UV protection to the eye 150 by reducing or minimizing reflections 136 from the back or concave side 136 of the lens 132. As the AOI on the back side of the lens Ø 139 is non-zero (e.g., between 10 and 45 degrees), the AR coating 137 reduce reflections of incident light at these AOIs.

The AR coating 137 comprises a multilayer stack of interferential thin layers. This multilayer stack may comprise alternating layers of a dielectric material of high refractive index and a dielectric material of low refractive index. When deposited on a transparent substrate, the coating reduces the amount of light reflected by the surface of the substrate and therefore increases the amount of light that is transmitted by the substrate. A substrate thus coated therefore has a higher ratio of transmitted light to reflected light ratio, thereby improving the visibility of objects placed behind it. To maximize the antireflection effect, it is may be preferable to coat both faces (front and rear faces) of the substrate with an AR coating.

In the coating 137 shown in FIG. 1, the AR stack comprises alternating layers of Low index (LI) Silicon Dioxide (silica), SiO₂, with an index of refraction of 1.46, and High Index (HI) Silicon Nitride, Si₃N₄, with an index of refraction of 2.02. The noted indices of refraction are evaluated at a wavelength of 510 nm. The coating includes five layers total, starting with SiO₂ over a Hard Coat (HC 1.5), with thicknesses outlined below in TABLES 4A, 4B, and 6.

Generally, an inventive AR coating applied to an ophthalmic lens is designed and optimized to reduce reflection on the lens surface in the visible region, typically within the spectrum range of from 380 to 780 nm. In general, the mean light reflection in the visible region on the front and/or back side of an ophthalmic lens is from 1.5% to 2.5%.

An inventive AR coating may also be designed and optimized to reduce reflection on the back surface of the lens within the UVA band of from 315 to 400 nm and/or the UVB band of from 280 to 315 nm, in addition to the visible region. These UVA and UVB bands can be harmful to the retina.

### Sputtered AR Coatings and On-Block Manufacturing (OBM)

The developed coating and method for deposition is relevant and suited well to the OBM process. The OBM process is outlined in order to clarify the context of the coating process within the overall OBM process.

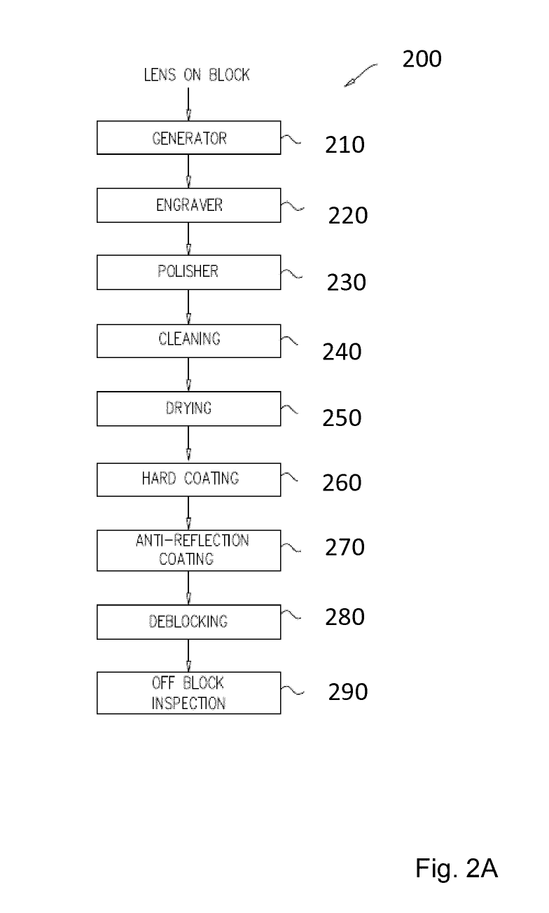

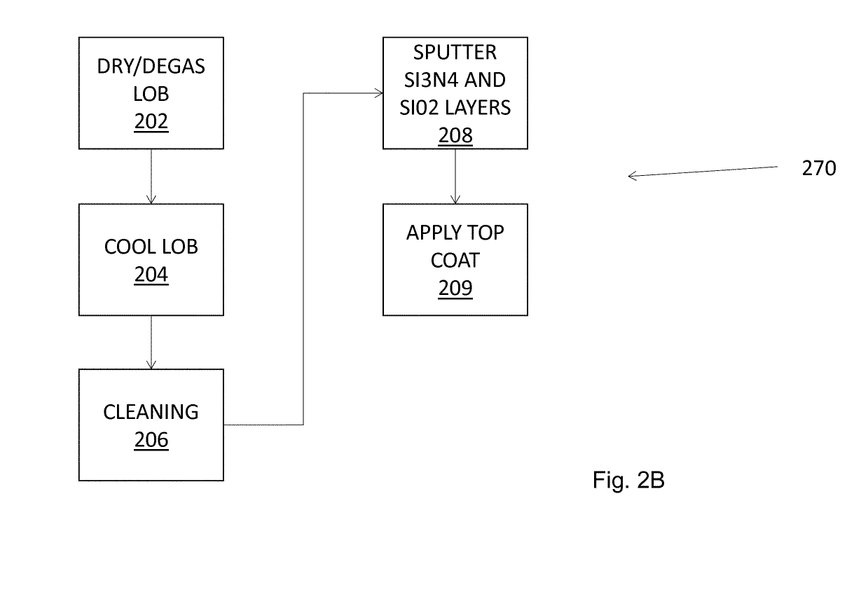

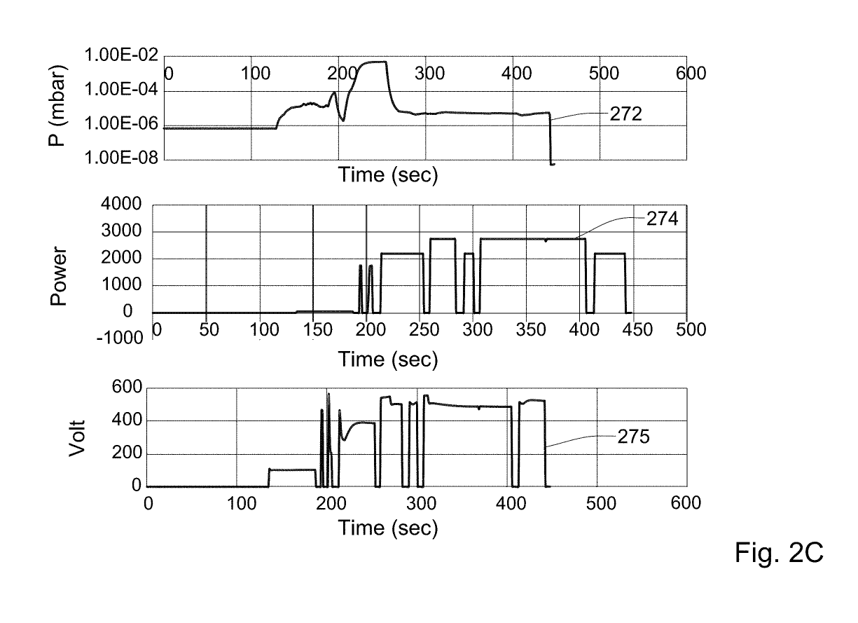

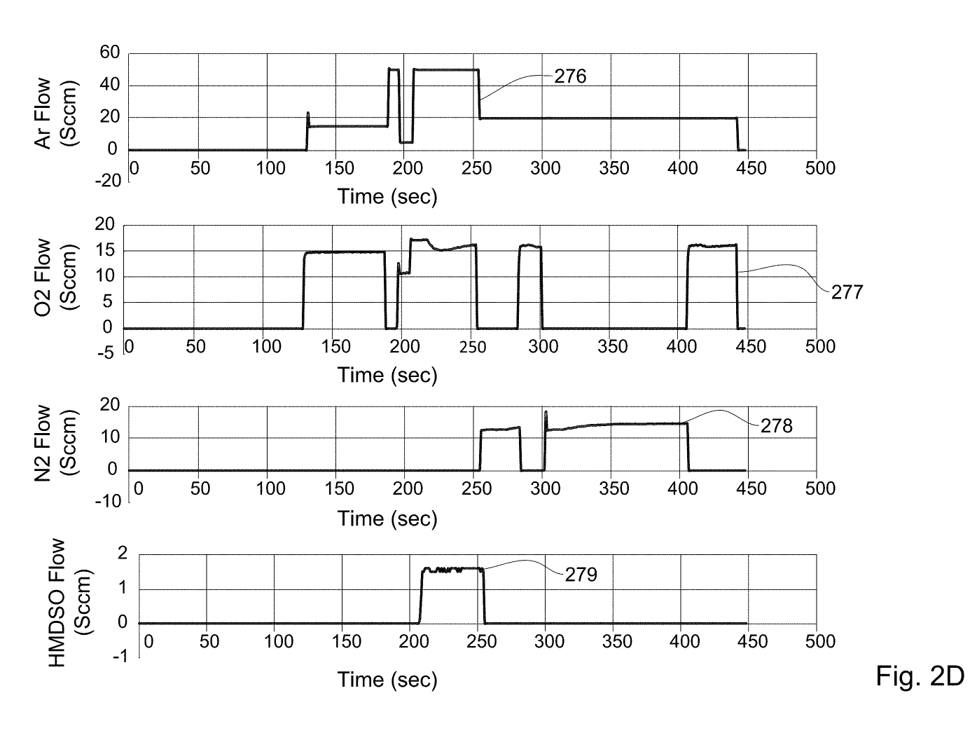

FIGS. 2A and 2B illustrate an on-block manufacturing (OBM) process 200 for ophthalmic lenses with a back side AR coating like the lens 132 shown in FIG. 1. After the lens blank has been blocked to from a lens on block (LOB), its back surface is machined in two phases: a coarse machining phase at step 210 to generate the overall shape (e.g., using a generator), and a fine machining phase at step 230 to polish the surface and achieve the desired surface qualities. An engraving step 220 can be performed between the coarse machining and the fining machining to engrave semi-visible and/or visible marks on the lens to, for example, guide subsequent manufacturing steps. After the back surface machining, the back surface is usually cleaned at step 240 and dried at step 250 before being coated with, for example, a hard coating at step 260 and/or an AR coating at step 270 as described in greater detail below with respect to FIG. 2B. Then the coated lens is removed, in a step 280 called deblocking, from the lens block for edging, which involves cutting the lens into an appropriate shape to fit the lens frame. An off-block inspection step 290 can be performed after the lens is removed from the block.

The layers of the antireflective coating are commonly deposited under vacuum, using methods such as chemical vapor deposition (CVD), Physical Vapor deposition (PVD), ion-beam sputtering, cathode sputtering, etc. The LOB presents a challenge since the adhesive layer that holds the lens to the block is formed of a resin that can retain moisture and/or gas, and the generating step 210, the polishing step 230 and the cleaning step 240 involve wet and harsh processes. The LOB complex should be degassed before being subjected to a vacuum.

FIG. 2B illustrates the AR coating step 270 in greater detail. The AR coating can be deposited using ion beam sputtering. Ion beam sputtering deposition is faster than the physical vapor deposition methods, reducing the deposition duration from 40 minutes to under 15 minutes (e.g., to about 5, 6, 7, 8, 9, or 10 minutes). It is also compatible with both blocked lenses and 1.6/1.67/Polycarbonate/Trivex substrates. As a result, sputtering can be accomplished without deblocking the lens (removing the lens from the block as in step 280).

After the hard coat has been applied to the back side of the lens, the LOB is dried/degassed in an oven in step 202 (e.g., 1 hour for highly absorptive materials, such as trivex and lenses with an index of refraction of 1.5; for other materials, 5-10 minutes may suffice).

In step 204, the LOB is cooled, e.g., for 5-10 minutes at room temperature. An optional vacuum degassing step can be inserted between the cooling step 204 and the antistatic treatment 206. The LOB may be degassed in an oven at a temperature of anywhere from 30-70 degrees (e.g., 55 degrees). Degassing for most plastics takes about 10 minutes, but for CR lenses it can take 1 hour. The drying and degassing of the LOB facilitate the vacuum for the reactive ion-beam sputtering deposition of the AR coating 270. The LOB may be cooled at room temperature, e.g., for five minutes, before proceeding to the next processing step.

In step 206, the LOB is cleaned, for example, by being subject to an anti-static treatment with ionized air. Ionized (compressed) air cleans dust particles from the lens and neutralizes surface static electricity on the lens surface to prevent more dust from settling on the lens surface. The ionized air contains positive and negative ions, which eliminate charges on the surface.

In step 208, alternating layers of SiO₂ and Si₃N₄ are sputtered onto the back side of the lens to form the AR coating. Sputtering may take 7-15 minutes, depending on the number of layers and the layer materials.

The AR coating deposition by reactive ion-beam sputtering in step 208 is a process involving various parameters, which can be tuned for each layer deposition. These steps include a pre-processing etching step to prepare the surface, a target cleaning step, an adhesive layer step, and a buffer step, generating the first silicon dioxide (SiO₂) layer. Then silicon nitride (Si₃N₄) and silicon dioxide are applied in alternating layers. The parameters include flow rates and delays from shutter open for the various gasses, including the inert ionizing gas (Ar) and the reactive gasses (N₂, O₂), producing SiO₂ and Si₃N₄ with a silicon target within the sputtering chamber. For each of the steps, a vacuum must be reached with a pressure of, for example, 2.0×10⁻⁴ mbar, 8.0×10⁻⁴ mbar, or lower. The sputtering recipe is a general one, and can be calibrated for any sputter coater available.

TABLE 1A (below) outlines suitable recipe parameters for each step when using a Satisloh SP200 Sputter Coater to make an example AR coating. The factors used to reach the coating using the Satisloh SP200 Sputter Coater are outlined in TABLE 1B (below). TABLE 2 (below) gives approximate actual values of the parameters implemented by the Satisloh SP200 Sputter Coater programmed with the recipe and factors of TABLES 1A and 1B, respectively. The recipe for each step determines the thickness of the respective layer. The recipe can be tweaked using a calibration method for each layer, and the factors can vary within +/−10% or +/−20%. The values of the implemented parameters can be found in FIGS. 2C and 2D. The pressure 272 in the sputtering chamber, the input power 274, and the voltage 275 are monitored over the duration of the sputtering. The flow rates of the various gasses into the chamber, including the sputtering gas Argon (Ar) 276, Oxygen (O₂), Nitrogen (N₂) 278, and Hexamethyldisiloxane (HDMSO) 279 are monitored over the sputtering duration and plotted in FIG. 2D.

TABLE 1B
Factors for a Satisloh SP200 Sputter Coater

| | Step number | | | | | | | |
|---|---|---|---|---|---|---|---|---|
| | 1 | 2 | 3 | 4 | 5 | 6 | 7 | 8 |
| Layer Type | Etching | TargClean | Ad1750 | Buffer | SiN | SiO | SiN | SiO |
| Shutter | 0.83 | 1.00 | 1.00 | 1.12 | 0.23 | 0.29 | 1.56 | 0.76 |
| Open [fact] | | | | | | | | |
| Adaption | 0.0 | 0.0 | 0.0 | 1.0 | 1.0 | 1.0 | 1.0 | 1.0 |
| [%] | | | | | | | | |
| Ar Delay | 0 | −2 | 0 | 0 | 0 | 0 | 0 | 0 |
| [ds] | | | | | | | | |
| O2 Flow | 0.0 | 0.0 | 0.0 | −1.0 | 0.0 | 0.0 | 0.0 | 0.0 |
| [dsccm] | | | | | | | | |
| O2 Delay | −2 | 0 | 0 | 0 | 0 | 0 | 0 | 0 |
| [ds] | | | | | | | | |
| Power | −2 | −2 | 0 | 0 | 5 | 0 | 0 | 0 |
| Delay [ds] | | | | | | | | |

Using a sputtering process like the one(s) disclosed above, an OBM process can produce a pair of AR-coated eyeglass lenses in less than a business day or two. Depending on the business model, some OBM labs offer a guaranteed delivery time of less than 8 hours, less than 3 hours, or less than 90 minutes. The guaranteed delivery time can be measured from receiving a prescription to a point at which the framed eyeglasses are ready for shipment. In some fast OBM labs, for example in urban areas, the guaranteed delivery time can include the shipment as well. For more information on the OBM process, see, e.g., International Application No. PCT/IB2015/002137 or International Application No. PCT/IB2015/002125, each of which is incorporated herein by reference.

The shortened time for the AR coating step using sputtering for the back side AR coating reducing UV reflections impacts the guaranteed delivery time and provides an advantage.

### Coating Complex

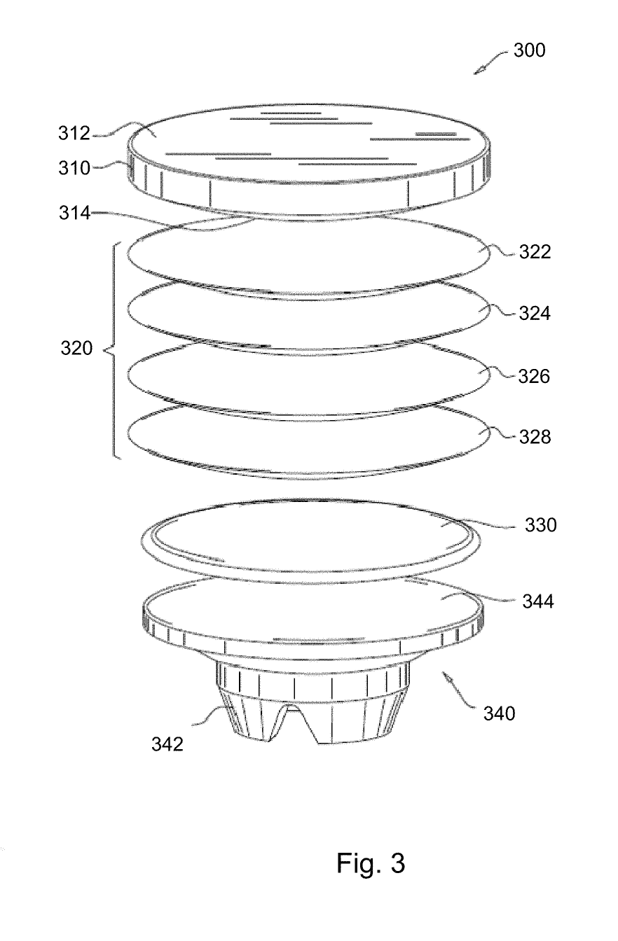

FIG. 3 shows an exploded view of a blocked lens 300 that can be used in OBM processing according to the processes illustrated in FIGS. 2A and 2B. The blocked lens 300 includes a lens blank 310 with a back surface 312 and a front surface 314. The front surface 314 may be coated with multiple layers, collectively referred to as coating layers 320. The coating layers 320 can include, for example, a hard coating 322, an anti-reflection coating 324, a hydrophobic top coating 326, and a grip coating 328, among others. Additional coatings may include an anti-fog coating, a mirror coating, a photochromic coating, or a polarization coating.

The AR coating may be deposited onto any substrate, and preferably onto organic lens substrates, for example a thermoplastic or thermosetting plastic material. Thermoplastic materials to be suitably used for the substrates include (meth)acrylic (co)polymers, especially methyl poly(methacrylate) (PMMA), thio(meth)acrylic (co)polymers, polyvinylbutyral (PVB), polycarbonates (PC), polyurethanes (PU), poly(thiourethanes), polyol allylcarbonate (co)polymers, thermoplastic copolymers of ethylene/vinyl acetate, polyesters such as polyethylene terephthalate (PET) or polybutylene terephthalate (PBT), polyepisulfides, polyepoxides, polycarbonate/polyester copolymers, cycloolefin copolymers such as copolymers of ethylene/norbornene or ethylene/cyclopentadiene, and combinations thereof.

The assembly (also referred to as lens on block, or simply LOB) of a lens blank 310 coupled with a lens block 340 can be coated with multiple layers as shown in FIG. 3. Non-limiting example layers may comprise: an adhesive layer, silica grip layer, satin hydrophobic layer, etc. TABLE 3 provides an overview of the LOB complex layers that may be used in OBM processes, while TABLES 4A and 4B give detailed non-limiting examples of back side AR coatings reducing UV exposure tailored for two different substrates: one marketed as Mitsui Resin 8 (MR8) with an index of refraction of 1.6 (TABLE 4A) and another marketed as MR7 with an index of refraction 1.67 (TABLE 4B).

### AR Coating Optical Performance

The optical performance of an AR coating can be characterized using a number of different parameters as explained in greater detail below. Generally, an inventive AR coating offers better optical performance than previous coatings under a variety of conditions, including conditions experienced by the average user.

### Characterizations

The optical performance of an AR coating can be characterized by the AR coating's reflectance spectrum over a defined range of wavelengths, and for a defined AOI. The mean reflection factor Rₘ and maximum reflectance Rₘₐₓ characterize the reflectance spectrum for a selected wavelength range. Rₘ is defined in the ISO 13666:1998 Standard as the arithmetic mean reflectance in the range 400 and 700 nm. The reflectance can also be evaluated, for example, over the ultraviolet (UV) region (280-380 nm), over the visible (VIS) region (380-750 nm), and/or over the UV-VIS region (280-750 nm) or some fraction(s) thereof.

The reflectance over the UV region can indicate the extent of eye protection harmful rays, and reflectance of the VIS region can indicate the extent of reduction of glare from visible light, which can be particularly uncomfortable when wearing sunglasses. The UV-VIS reflectance measurements give an overall picture of minimizing light exposure from rays reflected off the back side of the lens, from light sources located behind the wearer.

Another measure of performance of an AR coating is the AR coating's weighted average reflection factor in the UV region (R_{UV}), which varies with the AOI. The weighted average reflection, R_{UV}, factor in the ultraviolet region, between 280 or 290 and 380 nm, for an AOI of 30 degrees and 45 degrees may be defined through the relation weighted by the W(λ) function defined according to the ISO 13666:1998 Standard:

TABLE 1A
Sputtering Recipe for a Satisloh SP200 Sputter Coater

| | | Shutter | Adapt- | Ar | Ar | O₂ | O₂ | N₂ |
|---|---|---|---|---|---|---|---|---|
| | Time | Open | ation | Flow | Delay | Flow | Delay | Flow |
| Step | [s] | [s] | [%] | [sccm] | [s] | [sccm] | [s] | [sccm] |
| 1.Pre- | 70 | 60 | 0 | 15 | 0 | 15.0 | 5 | 0 |
| treatment | | | | | | | | |
| [Etching] | | | | | | | | |
| 2. Clean | 10 | 0 | 0 | 50 | 5 | 0.0 | 0 | 0 |
| 3. Ad1750 | 8 | 5 | 0 | 5 | 0 | 11.0 | 3 | 0.0 |
| 4. SiO₂ | 41-42 | 34-35 | 1 | 50.0 | 0 | 17.5-18.5 | 3 | 0 |
| buffer | | | | | | | | |
| 5. Si₃N₄ | 68 | 60 | 1 | 20.0 | 0 | 0 | 0 | 13 |
| 6. SiO₂ | 43 | 40 | 1 | 20.0 | 0 | 16.5 | 3 | 0.0 |
| 7. Si₃N₄ | 68-69 | 60-61 | 1 | 20.0 | 0 | 0 | 0 | 13.0-13.5 |
| 8. SiO₂ | 43 | 40 | 1 | 20.0 | 0 | 16.5 | 3 | 0.0 |

| | N₂ | | Power | | | | |
|---|---|---|---|---|---|---|---|
| Step | Delay | Power | Delay | HMDSO | Voltage | Frequency | |
| (Contined) | [s] | [W] | [s] | [sccm] | [V] | [kHz] | Pulse |
| 1.Pre- | 0 | 50 | 5 | 0 | 0 | 90 | 5.0 |
| treatment | | | | | | | |
| [Etching] | | | | | | | |
| 2. Clean | 0 | 1750 | 5 | 0 | 0 | 90 | 3.0 |
| 3. Ad1750 | 0 | 1750 | 0 | 0 | 0 | 150 | 3.0 |
| 4. SiO₂ | 0 | 2200 | 3 | 1.7 | 380-400 | 60 | 5.0 |
| buffer | | | | | | | |
| 5. Si₃N₄ | 3 | 2750 | 5 | 0 | 490 | 150 | 3.0 |
| 6. SiO₂ | 0 | 2200 | 0 | 0 | 525 | 60 | 5.0 |
| 7. Si₃N₄ | 3 | 2750 | 5 | 0 | 490 | 150 | 3.0 |
| 8. SiO₂ | 0 | 2200 | 0 | 0 | 525 | 60 | 5.0 |

TABLE 2
Actual Sputtering Parameters

| | | Actual | | |
|---|---|---|---|---|
| | Time | Shutter | Actual Ar | Actual O₂ |
| Step | [s] | Open [s] | Flow [sccm] | Flow [sccm] |
| 1.Pretreat- | 70 | 55 (50-70) | 15 | 15.0 |
| ment | | | | |
| [Etching] | | | | |
| 2. Clean | 10 | 1 (1-5) | 50 (45-55) | 0.0 |
| 3. Ad1750 | 8 | 7 (5-10) | 5 (4.5-5.5) | 11.0 (10-15) |
| 4. SiO₂ | 41 | 45 (34-55) | 50.0 (45-55) | 14.3 (14.0-17.5) |
| buffer | | | | |
| 5. Si₃N₄ | 68 | 37 (30-45) | 20.0 (18-22) | 0 |
| 6. SiO₂ | 43 | 20 (15-40) | 20.0 | 16 (14-17) |
| 7. Si₃N₄ | 68 | 64 (45-80) | 20.0 | 0 |
| 8. SiO₂ | 43 | 34 (30-40) | 20.0 | 16.5 (14-17) |
| Step | Actual N₂ | | Actual | |
| (Con- | Flow | Actual | HMDSO | Actual |
| tinued) | [sccm] | Power [W] | [sccm] | Voltage [V] |
| 1.Pretreat- | 0 | 45-55 | 0 | 0-150 |
| ment | | | | |
| [Etching] | | | | |
| 2. Clean | 0 | 1750 | 0 | 0 |
| 3. Ad1750 | 0.0 | 1750 | 0 | 0 |
| 4. SiO₂ | 0 | 2200 | 1.6 (1.5-1.7) | 390 (370-410) |
| buffer | | (2000-2500) | | |
| 5. Si₃N₄ | 12.3 | 2750 | 0 | 490 (480-570) |
| | (10-15) | (2740-2760) | | |
| 6. SiO₂ | 0.0 | 2200 | 0 | 525 (490-530) |
| | | (2000-2500) | | |
| 7. Si₃N₄ | 13 | 2750 | 0 | 490 (480-570) |
| | | (2740-2760) | | |
| 8. SiO₂ | 0.0 | 2200 | 0 | 525 (490-530) |
| | | (2000-2500) | | |

TABLE 3
Lens and Coating Complex

| Layer/Material | Physical Thickness | | FIG. 3 |
|---|---|---|---|
| Lens blocking piece | | | 340 |
| Adhesive | 0.5-3 | mm | 330 |
| Grip coat | 1-20 | nm | 328 |
| Hydrophobic layer | 1-20 | nm | 326 |
| AR coating | 0.1-1 | um | 324 |
| Hard coating (HC) | 1-10 | um | 322 |

| | |
|---|---|
| Lens | 310 |

TABLE 4A
An Example Back Side UV AR Coating

| | Physical | Optical | Refractive | |
|---|---|---|---|---|
| Layer Material | Thickness (nm) | Thickness | Index | Layer No. |
| Air | | | | |
| Silicon Dioxide | 69.50 | 0.79679 | 1.46 | 6 |
| Silicon Nitride | 103.00 | 1.63184 | 2.02 | 5 |
| Silicon Dioxide | 26.80 | 0.30716 | 1.46 | 4 |
| Silicon Nitride | 15.75 | 0.24953 | 2.02 | 3 |
| Silicon Dioxide | 100.34 | 1.150000000 | 1.46 | 2 |
| Hard Coat | 250.00 | 0.02941 | 1.50 | 1 |
| Substrate (Lens, MR8) | | | 1.6 | |

TABLE 4B
Another Example Back Side UV AR Coating

| | Physical | Optical | Refractive | Layer |
|---|---|---|---|---|
| Layer Material | Thickness (nm) | Thickness | Index | No. |
| Air | | | 1.00 | |
| Silicon Dioxide | 83.14 | 0.95289525 | 1.46 | 6 |
| Silicon Nitride | 100.73 | 1.59587922 | 2.02 | 5 |
| Silicon Dioxide | 27.35 | 0.31346747 | 1.46 | 4 |
| Silicon Nitride | 10.42 | 0.16508549 | 2.02 | 3 |
| Silicon Dioxide | 100.34 | 1.150000000 | 1.46 | 2 |
| Hard Coat | 250.00 | 0.02941 | 1.50 | 1 |
| Substrate | N/A | | 1.67 | |
| (Lens, MR7) | | | | |

$${R}_{UV} = \frac{{\int }_{280}^{380} W ( λ ) \cdot R ( λ ) \cdot d λ}{{\int }_{280}^{380} W ( λ ) \cdot d λ}$$

where R(λ) represents the lens spectral reflection factor at a given wavelength, and W(λ) represents a weighting function equal to the product of the solar spectrum irradiance Eₛ (λ) and the efficiency relative spectral function S(λ).

### Values

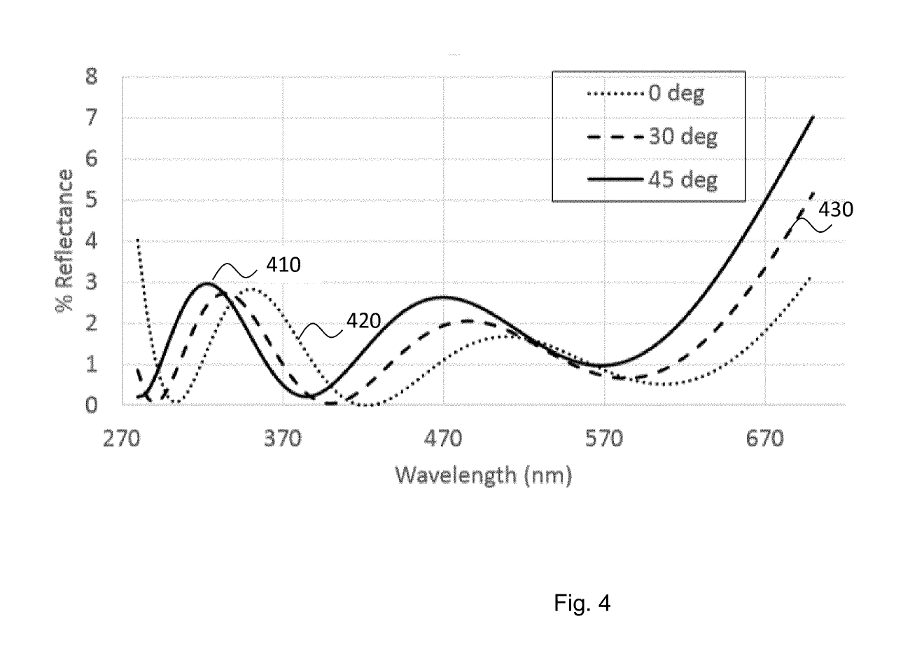

FIG. 4 is a plot of the reflectance spectra of the AR coating outlined in TABLE 4A (above), at normal angle of incidence 420, 30° AOI 430, and 45° AOI 410 as a function of wavelength. In the visible range, the reflectance is under 5% even at normal incidence. The values of R_{UV}, Rₘ, and Rₘₐₓ for each of the reflectance spectra in FIG. 4 is outlined in the TABLE 5 (below).

TABLE 5
Optical Performance varies with AOI

| | Rᵤᵥ (%) | Rₘ (%) | Rₘ (%) | Rₘₐₓ (%) |
|---|---|---|---|---|
| | (280- | (400- | (280- | (280- |
| AOI (degrees) | 380 nm) | 700 nm) | 700 nm) | 700 nm) |
| 0 | 1.39 | 1.11 | 1.28 | 4.01 |
| 30 | 1.7 | 1.70 | 1.56 | 5.16 |
| 45 | 2.14 | 2.433.02 | 2.1471 | 7.0284 |

TABLE 6 (below) shows R_{UV} calculations for the AR coating of TABLE 4 (above) with an AOI is 35°. The percentage R_{UV} indicated is that with layer at the limit, and the rest of the layers at the “standard thickness,” and calculated as defined above in the equation for R_{UV}. For example, if the thickness of Layer 2 in TABLE 6 is decreased to 61 nm while maintaining the thickness of the rest of the layers, the R_{UV} of the resulting coating is 3%, while if the thickness of Layer 2 is increased to 77 nm, the R_{UV} of the resulting coating is 1.7%. At the standard thickness, R_{UV} is about 2.1%. The Lower and Upper control limits for the thickness of each layer is designed to maintain a maximum reflectance for the coating complex below 3.8%.

The thickness referred to in TABLES 4 and 6 is the physical thickness (distinguished from optical thickness, which varies with wavelength due to dispersion) range for each layer for maintaining a maximum reflectance of 3.3% between 280 and 600 nm, and a R_{UV} of 3.8%.

TABLE 6
R_{UV} Performance

| | | | Lower | Lower | Upper | Upper |
|---|---|---|---|---|---|---|
| | | | Control | Control | Control | Control |
| Layer | | Thickness | Limit | Limit | Limit | Limit |
| Medium | Material | (nm) | (nm) | % Ruv | (nm) | % Ruv |
| 1 | Air | | | | | |
| 2 | SiO2 | 69.52 | 61 | 3 | 77 | 1.7 |
| 3 | Si3N4(1) | 103.00 | 92 | 3 | 108 | 1.6 |
| 4 | SiO2 | 26.9 | 13.4 | 1.5 | 36 | 3 |
| 5 | Si3N4(1) | 15.75 | 8.5 | 1 | 22 | 3.8 |
| 6 | SiO2 | 100.34 | 0 | 0.8 | 200 | 2.1 |
| 7 | HC 1.5 | — | — | — | — | — |
| Substrate | MR8 | | | | | |
| Total | | 315.49 | | | | |

The total thickness of the antireflective coating is generally between 300 and 400 nm, less than 500 nm or 1 micron, and can be lower than 250 nm. The antireflective coating total thickness is generally higher than 100 nm, preferably higher than 150 nm.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of designing and making the technology disclosed herein may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output.

Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes (e.g., of designing and making the technology disclosed above) outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A lens on block comprising:
a block;
an ophthalmic lens blank having a front surface and a back surface;
an adhesive, disposed between the block and the front surface of the ophthalmic lens blank, to hold the ophthalmic lens blank to the block; and
an anti-reflection coating comprising at least five alternating layers of silicon nitride and silicon dioxide disposed on the back surface of the ophthalmic lens blank.

2. The lens on block of claim 1, wherein the at least five alternating layers of silicon nitride and silicon dioxide comprise:
a first layer of silicon dioxide having a thickness between 61 nm and 77 nm;
a first layer of silicon nitride disposed on the first layer of silicon dioxide and having a thickness between 92 nm and 108 nm;
a second layer of silicon dioxide disposed on the first layer of silicon nitride and having a thickness between 13.4 nm and 36 nm;
a second layer of silicon nitride disposed on the second layer of silicon dioxide and having a thickness between 8.5 nm and 22 nm; and
a third layer of silicon dioxide disposed on the second layer of silicon nitride and having a thickness between 40 nm and 200 nm.

3. The lens on block of claim 1, further comprising a front side coating disposed on the front surface of the ophthalmic lens blank.

4. The lens on block of claim 1, wherein the anti-reflection coating further comprises at least one of a back side hard coating or a hydrophobic layer.

5. The lens on block of claim 1, wherein the at least five anti-reflection coating comprises seven alternating layers of silicon nitride and silicon dioxide.

6. The lens on block of claim 1, wherein the lens blank is made of an organic substrate.

7. The lens on block of claim 1, wherein the anti-reflection coating has a maximum reflectance of about 5% at an angle of incidence of about 0 degrees over a wavelength range from about 400 nm to about 700 nm.

8. The lens on block of claim 1, wherein the lens has an UV weighted average reflection factor of less than about 5% over angles of incidence within a range of about 0° to about 45°.

9. The lens on block of claim 8, wherein the UV weighted average reflection factor is less than about 2.5% over angles of incidence within a range of about 0° to about 45°.

10. A method of forming an anti-reflection coating on a lens on block (LOB), the LOB comprising an ophthalmic lens blank affixed to a lens block with an adhesive, the method comprising:
heating the LOB so as to dry and/or degas the LOB;
allowing the LOB to cool;
cleaning a back surface of the ophthalmic lens blank of the LOB; and
sputtering alternating layers of dielectric material on the back surface of the ophthalmic lens blank of the LOB to form the anti-reflection coating.

11. The method of claim 10, wherein the heating comprises heating the LOB for at least 5 minutes.

12. The method of claim 10, wherein the heating comprises heating the LOB for at least 60 minutes.

13. The method of claim 10, wherein the cleaning comprises an anti-static treatment with ionized air.

14. The method of claim 10, wherein the sputtering comprises reactive ion-beam sputtering.

15. The method of claim 10, wherein the sputtering comprises:
disposing a first layer of silicon dioxide on the back surface of the ophthalmic lens blank of the LOB, the first layer having a thickness between 40 nm and 200 nm;
disposing a first layer of silicon nitride on the first layer of silicon dioxide, the first layer of silicon nitride having a thickness between 8.5 nm and 22 nm;
disposing a second layer of silicon dioxide on the first layer of silicon nitride, the second layer of silicon dioxide having a thickness between 13.4 nm and 36 nm;
disposing a second layer of silicon nitride disposed on the second layer of silicon dioxide, the second layer of silicon nitride having a thickness between 92 nm and 108 nm; and
disposing a third layer of silicon dioxide on the second layer of silicon nitride, the third layer of silicon dioxide having a thickness between 61 nm and 77 nm.

16. The method of claim 10, further comprising: vacuum degassing the LOB between the cooling and the cleaning.
